(19) United States
(12) Patent Application Publication
(10) Pub. No.: US 2012/0159773 A1
(43) Pub. Date: Jun. 28, 2012

(54) METHOD FOR PRODUCING AN ELECTROCHEMICAL CELL

(75) Inventor: Guenter Eichinger, Altenstadt (DE)

(73) Assignee: LI-TEC BATTERY GMBH, Kamenz (DE)

(21) Appl. No.: 13/382,403

(22) PCT Filed: Jun. 24, 2010
(86) PCT No.: PCT/EP10/03878

§ 371 Date: Mar. 16, 2012

(30) Foreign Application Priority Data
Jul. 10, 2009 (DE) 10 2009 032 523.9

(51) Int. Cl. H01M 2/08

(52) U.S. Cl. 29/623.2

(57) ABSTRACT

Method for producing an electrochemical cell (1), wherein the electrochemical cell (1) comprises at least one electrode stack that is received inside a jacket (2), wherein the jacket (2) is formed by at least two jacket parts (3), wherein each jacket part (3) comprises at least one seam surface (5) with which the jacket parts (3) can be brought at least partially in contact, comprising the following method steps: adding a defined amount of auxiliary sealant (9) at least indirectly to a delimited section (8) of the seam surface (5) of at least one jacket part (3); bringing the seam surface (5) of one of the jacket parts (3) in contact with the seam surface (5) of another jacket part (3); subsequently applying heat to the seam surfaces (5).

The present invention relates to a method for producing an electrochemical cell.

A method for producing an electrochemical cell is known from DE 600 04 118 T2. The electrochemical cell comprises contact lugs, which establish an electrical connection between the cell interior and the cell exterior. The cell housing is formed in two parts and has upper sealing layers and lower sealing layers, which each form a laminate structure for sealing the electrochemical cell along sealing channels. The sealing layers have at least three layers, a polymer layer, a metal layer, and an adhesive layer being provided. The lugs act as a barrier between the adhesive layers and prevent the formation of an optimum hermetic seal between these layers. A pretreatment of the contact lugs before the closing of the cell housing is performed for better sealing in the area of the contact lugs. Resin films are shaped onto the contact lugs.

Electrochemical cells have current conductors as an important functional element, which conduct the electrical energy from the electrodes in the interior of the electrochemical cell outward. A good seal between the current conductors and the jacket of the electrochemical cell is required in this case, because otherwise material from the battery cell interior, in particular electrolyte material or reaction products of the electrolyte, can escape outward. In the case of lithium-ion cells, the seal is particularly important, since penetrating moisture can irreversibly damage the electrochemical cells or make them nonfunctional.

A composite film can be used for the jacket of an electrochemical cell, which can comprise a metal layer, in particular an aluminum layer. The composite film typically has a hot-sealable polymer layer on its inner side. This layer can have a cross-sectional thickness of significantly less than 100 μm. A bond having good adhesion between the sealing layers of two composite films is achieved during the closing of the electrochemical cell by a suitable hot sealing tool. However, it is to be ensured in the seal on the conductors that the adhesion of the sealing layer on the metal of the current conductors is sufficiently stable and security against detachment of the sealing layer at the current conductors is maintained in spite of the chemical reaction of electrolyte used in the electrochemical cell.

In principle, the seal in the area of the current conductors requires special attention, in particular if the composite film has a relatively thin polymer layer as the sealing layer, which cannot reliably compensate for thickness differences on the conductor. Since a current conductor can optionally have a layer thickness of greater than 0.2 mm, the danger in principle exists that gaps will form in the jacket in the area of the current conductors, which could result in leaks of the electrochemical cell.

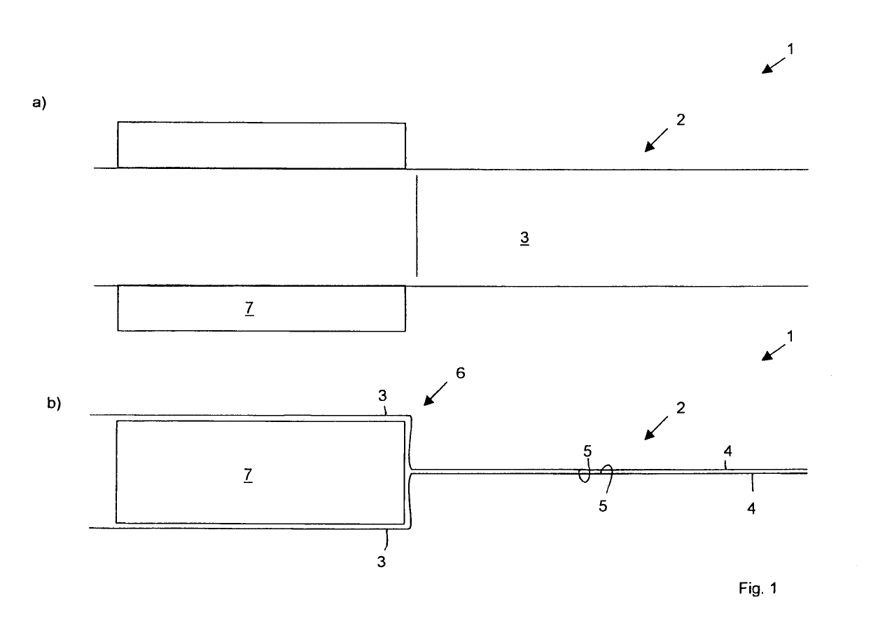

FIG. 1 shows a detail of an electrochemical cell according to the prior art. The jacket 2 of an electrochemical cell 1, which is formed from two jacket parts 3, is shown in detail therein. Each jacket part 3 has a peripheral seam section 4, the two jacket parts 3 largely being in contact with one another on seam surfaces 5 of the seam section 4. In an area of the current conductor feedthrough 6, a current conductor 7 extends through the jacket 2. The jacket clings to the current conductors 7 upon closing, so that steps may result on the seam points in the area of the current conductor feedthrough 6.

It is the object of the present invention to provide a method for producing an improved electrochemical cell. This object is achieved by a method according to Patent claim 1.

The electrochemical cell to be produced comprises at least one electrode stack, which is received inside a jacket of the electrochemical cell. The jacket has at least two jacket parts, the jacket parts each having at least one seam surface, on which the jacket parts can be at least partially brought into contact with one another. During the production of the electrochemical cell, a defined quantity of auxiliary sealant is at least indirectly applied to a delimited section of the seam surface of at least one of the jacket parts. Furthermore, the seam surface of one of the jacket parts is brought into contact with the seam surface of one of the other jacket parts. The application of the defined quantity of auxiliary sealant to the seam surface can be performed either before the application of the seam surface of one of the jacket parts to the seam surface of one of the other jacket parts or it can be performed simultaneously. In the case of simultaneous application, the defined quantity of auxiliary sealant is applied equally to the seam surfaces of two or more jacket parts. Subsequently, i.e., after a defined quantity of auxiliary sealant has been applied to the seam surface of at least one of the jacket parts and after the seam surface of one of the jacket parts has been applied to the seam surface of another of the jacket parts, heat is applied to the seam surfaces. Sealing of the seam surfaces, which are pressed against one another, of the different jacket parts can be performed by the application of heat. Furthermore, sealing of the seam surfaces can be performed with the defined quantity of auxiliary sealant with the seam surface. For this purpose, heat is preferably applied to the respective point to be sealed to an extent such that the respective areas to be sealed are heated to a temperature which is greater than the respective melting temperatures of at least one material on the sections to be sealed.

The seal of the jacket can be improved by the application of auxiliary sealant, in particular in areas of the jacket which are subjected to increased strain, in particular increased mechanical strain, or in areas which could only be reliably sealed inadequately by means of the jacket because of their geometric shaping.

An auxiliary sealant can be understood as a material which is capable of producing a materially-bonded connection between different components, in particular different jacket parts. The auxiliary sealant can be used to seal at least sections of gaps between the jacket parts.

A defined quantity of auxiliary sealant is to be understood in particular as a quantity which is considered to be necessary and/or at least useful for the improved seal of an area of the jacket. A delimited section of the seam point is to be understood in particular in the scope of the present invention as a section which in particular does not extend to the entire seam surface. The extent of the delimited section is in particular at most one-half of the seam surface, in particular at most one-fourth of the seam surface, in particular at most 10% of the seam surface. In particular, the delimited section extends to an area of the seam surface which has an increased tendency to form gaps, i.e., to form leaks in the seam area, in particular because of the geometrical conditions and/or the mechanical strain. The delimited section can particularly be a section of the seam surface which is provided for contact with a current conductor which penetrates the jacket. Furthermore, the delimited section can be a subsection of the above-mentioned section.

As defined in the invention, an electrochemical cell is to be understood as a device which also comprises at least one electrode stack. The electrochemical cell additionally comprises a jacket, which seals the electrode stack gas-tight and liquid-tight in relation to an environment of the electrochemical cell. At least one current conductor is typically provided, which extends out of the jacket.

An electrode stack is to be understood as defined in the invention as an apparatus which, as an assembly of a galvanic cell, is also used to store chemical energy and to discharge electrical energy. Before the discharge of electrical energy, stored chemical energy is converted into electrical energy. During the charging, electrical energy supplied to the electrode stack or the galvanic cell is converted into chemical energy and stored. For this purpose, the electrode stack has multiple layers, at least one anode layer, one cathode layer, and one separator layer. The layers are laid or stacked one over another, the separator layer being at least partially arranged between an anode layer and a cathode layer. This sequence of the layers preferably repeats multiple times within the electrode stack. Some electrodes are particularly preferably electrically connected to one another, particularly connected in parallel. The layers are preferably rolled up into an electrode coil. The term “electrode stack” is also used for electrode coils hereafter.

A jacket is to be understood in the scope of the invention as an at least partial delimitation, which delimits the electrode stack to the outside. The jacket is preferably gas-tight and liquid-tight, so that a material exchange with the environment cannot occur. The electrode stacks are arranged inside the jacket. At least one current conductor, in particular two current conductors, extend out of the jacket and are used for connecting the electrode stacks. The current conductors extending to the outside preferably represent the positive pole terminal and the negative pole terminal of the battery cell. However, multiple current conductors can also extend out of the jacket, in particular four current conductors, which are connected in series to one another, two electrodes of different electrode stacks are thus connected to one another.

A current conductor is an element which is produced from a current-conducting material. It is used for conducting current between two points which are geometrically separate from one another. In the present case, a current conductor is connected to an electrode stack. The current conductor is preferably connected to all identical electrodes of an electrode stack, i.e., either to the cathodes or to the anodes. It is obvious that a current conductor is not simultaneously connected to the cathodes and anodes of an electrode stack, since this would result in a short-circuit. However, a current conductor can be connected to different electrodes of different electrode stacks, thus, for example, in a series circuit of the two electrode stacks. At least one current conductor extends out of the jacket and can be used for connecting the battery cells to the outside. The current conductor can be integrally formed with one or more electrodes. A delimitation between current conductor and electrode can be seen in that the current conductor is particularly not coated with active electrode material.

The auxiliary sealant can preferably change its shape during the application of heat. For this purpose, the auxiliary sealant is preferably produced from a meltable material, in particular from a polymer material. Through the shape change during the application of heat, the auxiliary sealant can preferably come into material contact with the seam surface of at least one of the jacket parts, in particular both jacket parts. The auxiliary sealant can preferably cling to the contour of the seam surface. Furthermore, clinging of the seam surface to the auxiliary sealant can also result. In this way, an improved sealing action of the jacket in the delimited section of the seam surface can result.

The seam surfaces are preferably arranged directly on one of the jacket parts. The jacket parts can come into contact directly with another component and seam surfaces directly arranged on the jacket parts can be connected to one another gas-tight and/or liquid-tight.

Alternatively thereto, the seam surface, at least on the delimited section, can be at least partially arranged on a presealing element separate from the jacket part. The presealing element is assigned to at least one of the jacket parts and provides the seam surface for this jacket part. The presealing element itself can in turn preferably be connected to the jacket part to form a seal. The presealing element can preferably be formed in the form of a presealing film. The presealing element can be assigned in each case to a single jacket part. Furthermore, the presealing element can also be assigned simultaneously to two jacket parts. In this case, the presealing element can at least partially provide the seam surfaces of both jacket parts. The presealing element can have a recess at least after its complete production or arrangement on the jacket parts. A current conductor can particularly be guided through such a recess. The contact surface of the presealing element on the current conductor represents the seam surface of at least one jacket part in such an application. The separate presealing element is connected in a further method step to at least one of the jacket parts, preferably fixedly connected. In addition, it can be connected to two jacket parts.

In a preferred embodiment, the seam surfaces of at least two jacket parts are arranged jointly on a separate presealing element, in particular a presealing film, in the delimited section. A current conductor is at least partially enclosed by the presealing element together with the auxiliary sealant. Subsequently, the current conductor is brought into contact with at least one of the jacket parts together with the presealing element. Subsequently, the current conductor is brought into contact with the other of the jacket parts together with the auxiliary sealant and the presealing element. The presealing element can, but does not have to, be formed in one part. In particular, the presealing element can be formed in two parts. The presealing element can be produced from a presealing film, which may be wound like an adhesive tape around a current conductor. The presealing element can also be produced from two or more separate sections of a presealing film, however. One section of the presealing film can first be arranged on one side of the current conductor, in particular on a conductor wide side. Subsequently, a further section of the presealing film is attached to the other side of the current conductor, in particular the other conductor wide side. The respective sections of the presealing film overlap the current conductor on the conductor narrow sides. The separate presealing films can come into contact with one another and can be closed with one another to form a seal. In such an embodiment, the seam surfaces, which are formed in this case by the surfaces of the presealing element facing toward the current conductor, are already in contact with the current conductor or a seam surface assigned to the respective other jacket part before the jacket parts themselves are in contact with the presealing element.

The seam surfaces and the auxiliary sealant are preferably produced from a similar material, in particular from an identical material. Two similar materials means in particular such material combinations between which a materially bonded connection is fundamentally possible without the addition of further separate adhesives or connection agents. In the preferred usage of an identical material for the seam surfaces and for the auxiliary sealant, in particular based on a polymer, the materially bonded connection can be produced favorably and reliably.

The seam surface preferably has an uneven contour on the delimited section. The seam surface can in principle be arranged at least largely in a plane. In sections of the seam surface which protrude out of the plane, i.e., which at least sectionally have an uneven contour, particular demands can be placed on the quality of the sealing. In particular on such uneven contours of the seam surfaces, it is favorable if the electrochemical cell is produced by means of an above-described method employing an auxiliary sealant.

The auxiliary sealant is preferably brought into at least indirect contact with a current conductor, in particular with a conductor narrow side of a current conductor. A conductor narrow side means a lateral delimitation surface of the current conductor in the area of the conductor feedthrough, which is smaller than the other side of the current conductor in this area. The other, wider side of the current conductor is designated as the conductor wide side. The seam surface is at least largely arranged in a plane which is oriented parallel to the conductor wide side. Therefore, a step can result in the area of the conductor narrow side, which is preferably to be compensated for by sealing. If the auxiliary sealant is at least indirectly in contact with the conductor narrow side, the auxiliary sealant can compensate for this step and particularly promote continuous guiding of the seam surface in the area of the conductor narrow side. Angular and/or stepped formations of the seam surface can therefore be reduced or avoided.

Further advantages, features, and possible applications of the present invention result from the following description in conjunction with the figures. In the figures:

FIG. 1 shows a detail of the seal area in the area of the current conductor feedthrough of an electrochemical cell according to the prior art,

a) in a top view,

b) in cross-section;

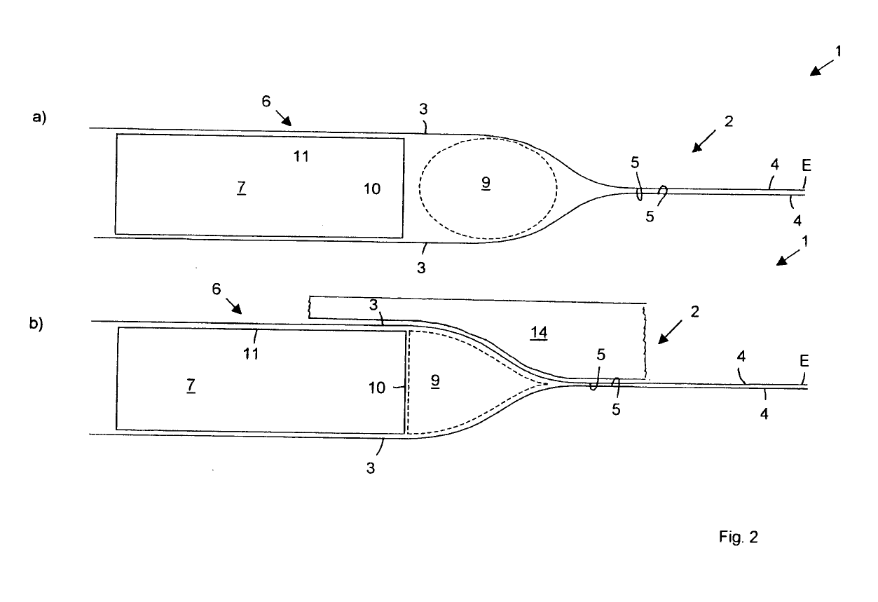

FIG. 2 shows a detail of the seal area in the area of the current conductor feedthrough of an electrochemical cell produced according to the invention in a first embodiment,

a) before the heat treatment,

b) after the heat treatment;

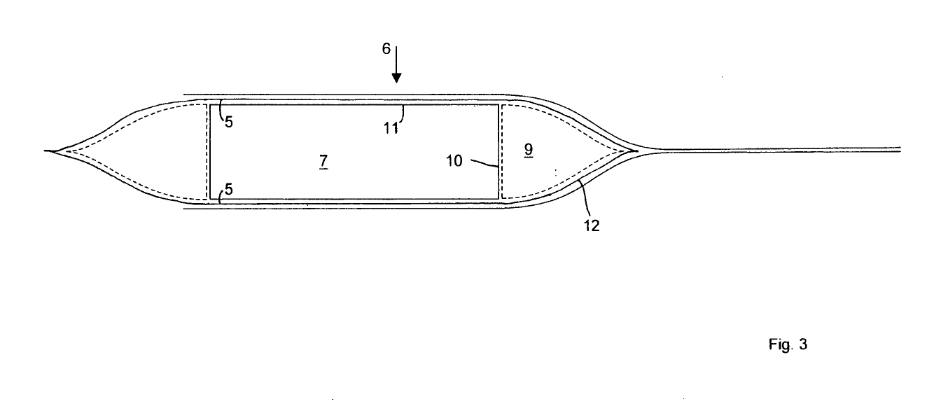

FIG. 3 shows a detail of the seal area in the area of the current conductor feedthrough of an electrochemical cell produced according to the invention in a second embodiment after the heat treatment;

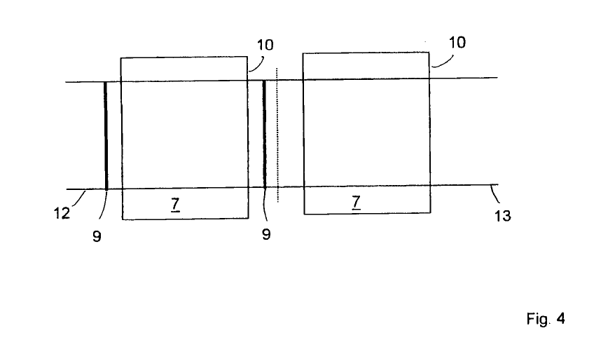

FIG. 4 shows two current conductors arranged on a presealing film having auxiliary sealant in a top view before the heat treatment;

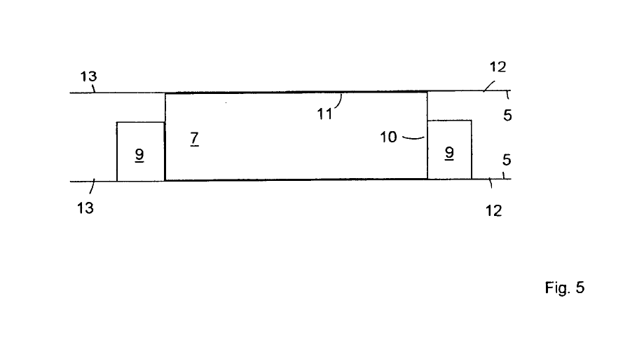

FIG. 5 shows a current conductor, which is arranged between two presealing film sections, having auxiliary sealant in a side view before the heat treatment;

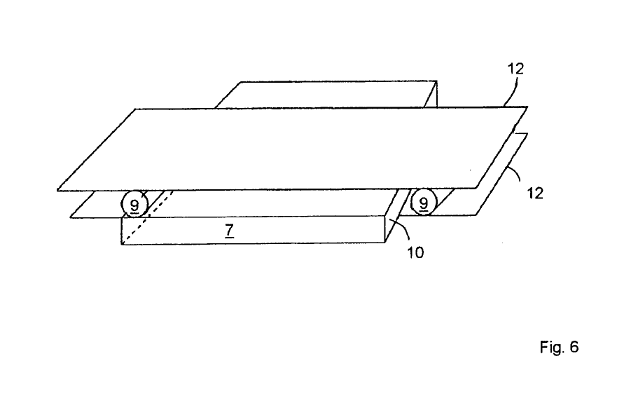

FIG. 6 shows a current conductor, which is arranged between two presealing film sections, having auxiliary sealant in a perspective view before the heat treatment;

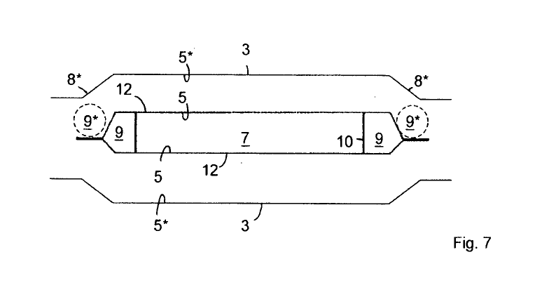

FIG. 7 shows a current conductor, which is arranged between two presealing film sections, having auxiliary sealant in a perspective view after the heat treatment.

FIG. 2 shows a detail of a seam section 4 of an electrochemical cell 1 during the production method according to the invention. The electrochemical cell 1 has a jacket 2, the jacket 2 being formed from two separate jacket parts 3. Each jacket part 3 is a laminated molded part, which was produced from a multilayered composite film by means of a deep-drawing process. The two jacket parts 3 are adjacent to one another on respective seam surfaces 5 of the seam section 4.

In an area of the current conductor feedthrough 6, in which a current conductor 7 extends outward through the jacket 2 from an interior of the electrochemical cell 1, a current conductor 7 is arranged between the seam surfaces 5 of the two jacket parts 3, so that the seam surfaces 5 of the two jacket parts 3 are not adjacent directly to one another in the area of the current conductor feedthrough 6. The current conductor 7 has a rectangular cross-section having a conductor narrow side 10 and a conductor wide side 11, the conductor narrow side 10 being smaller than the conductor wide side 11. The conductor narrow sides 10 and the conductor wide sides 11 extend through the jacket 2. The seam surfaces 5 are each arranged in a plane E, the seam surface 5 protruding out of the plane E in the area of the conductor feedthrough. The conductor wide side 11 is oriented parallel to the plane E. The conductor narrow side 10 is oriented perpendicular to the plane E. The seam surface 5 has an uneven contour in a transition section.

It can be seen in FIG. 2a) that a defined quantity of auxiliary sealant is applied in the area of the current conductor feedthrough 6 laterally to the current conductor 7. This defined quantity of auxiliary sealant 9 is only applied in the area of the uneven contour of the seam surface to the seam surfaces 5 of both jacket parts 3. The area of the uneven contour represents the delimited section in the meaning of the present invention, the delimitation of the delimited section being flowing and not being able to be established precisely on the basis of geometric fixed points of the jacket parts. The application of the defined quantity of auxiliary sealant 9 can be performed during the production of the jacket 2, when the jacket parts 3 are still not yet in contact with one another. The defined quantity of auxiliary sealant 9 is first applied to the seam surface 5 on the delimited section 8 of one jacket part 3. The other jacket part 3 is subsequently brought into contact with the first jacket part 3, whereby the already provided quantity of auxiliary sealant 9 also comes into contact with the seam surface 5 of the other jacket part 3.

FIG. 2b) shows the arrangement according to FIG. 2a) after heat has been applied to the seam section 4 of the electrochemical cell 1. A heatable sealing bar 14 is shown, which has a contour which corresponds to the desired contour of the seam surfaces 5 after the heat treatment. By the application of heat, the auxiliary sealant 9 at least partially melts in such a manner that it can change its shape. In consideration of the shape of the sealing bar 14, the auxiliary sealant 9 clings to the intermediate space of conductor narrow side 10 and seam surfaces 5 of the two jacket parts 3. In addition to the sealing bar 14 shown, a further sealing bar (not shown) is arranged on the other side of the electrochemical cell 1, which is also adapted to the contour of the seam surface 5 of the other jacket part. This sealing bar 14 is only shown in detail. The sealing bar 14 is formed in such a manner, however, that it can come into contact with the entire seam section 4 of one of the jacket parts 3. Furthermore, the jacket parts 3 also become elastically deformable through the heat application and cling to one another, in particular under the action of the sealing bar 14, and to the auxiliary sealant 9 and the current conductor 7. Furthermore, a polymer layer which is arranged on an inner side of the jacket parts 3 produced by means of composite film, is molten and can come into materially-bonded contact with the auxiliary sealant 9, the conductor wide side 11 of the current conductor 7, and a corresponding layer on the seam surface of the other jacket part 3. The arrangement shown in FIG. 2b) results, in which the auxiliary sealant 9 completely occupies the intermediate space between conductor narrow side 10 and jacket parts 3 and therefore produces a tight seal. It may be seen that the seam surfaces 5 have a continuous shape in the area of the current conductor feedthrough 6, without corners or jumps arising in the contour of the seam surfaces 5. The jacket 2 has reliable stability and security against undesired leaks in the area of the current conductor feedthrough 6 in this way.

In the embodiment according to FIG. 2, the seam surface 5 is always arranged directly on the respective jacket part 3. Alternatively, the seam surface 5 can also only be arranged sectionally directly on the respective jacket part 3 and can be provided sectionally on a separate presealing element 12, as explained in greater detail with reference to FIG. 3.

It may be seen in FIG. 3 that the jacket parts 3 do not come into direct contact with the current conductor 7 and the auxiliary sealant 9 in the area of the current conductor feedthrough 6. Rather, a separate presealing element in the form of a presealing film 12 is arranged between the jacket parts 3 and the current conductor 7 and the auxiliary sealant 9. The presealing film 12 provides the respective seam surfaces 5 of one of the jacket parts 3 at least in the delimited section 8 and in the area of the current conductor feedthrough 6. The seam surface 5, which is sectionally arranged on a presealing film 12 in the present case, is in direct contact with the current conductor 7 and the auxiliary sealant 9. The production method, which can result in an arrangement as in FIG. 3b), is explained in greater detail in following FIGS. 4 to 7.

FIG. 4 shows a continuous band 13 made of presealing film 12. Current conductors 7 are laid on the continuous band 13 at predefined intervals. Subsequently, molten sealable polymer is applied as auxiliary sealant to the band 13 by means of a nozzle. The polymer can be fibrous. The polymer can have a round or polygonal cross-section in the applied state. In a next method step, which is shown in FIG. 5, a second band 13 made of presealing film 12 is applied to the other side of the current conductor 7. The two conductor wide sides 11 are now at least partially covered with presealing film 12. The presealing film 12, which is laid on the top of the current conductor 7, is congruent to the presealing film 12 which is applied on the bottom to the current conductor 7. In a further step, the band 13 made up of the presealing film 12 is cut off laterally to the current conductor 7 and also laterally to the auxiliary sealant 9. The above-mentioned state is shown in a perspective view in FIG. 6.

In the next method step, the sealing bar according to FIG. 7 is externally applied to the presealing film 12. In this case, externally means that the sealing bar is moved toward the presealing film from the side which faces away from the current conductor 7. The sealing bar can substantially correspond to the sealing bar 14 described with respect to FIG. 2. However, since the surfaces to be sealed are smaller in the area of the presealing film than the surfaces to be sealed on the jacket according to FIG. 2, the sealing bar can now be implemented as smaller. A compression of the presealing film 12 occurs, the presealing film 12 coming into contact with the current conductor 7 or the auxiliary sealant 9, respectively, in the area of the current conductor 7 and the auxiliary sealant 9. Outside this area, the two presealing films 12 come directly into contact with one another.

In a next method step, a composite 15 thus prepared, made of presealing film 12, auxiliary sealant 9, and current conductor 7, can be applied in the area of the current conductor feedthrough 6 between the two jacket parts 3 and fixedly connected using a further seal to the jacket parts 3. The method applied for this purpose substantially corresponds to the method which was described with respect to FIG. 2, with the proviso that instead of the current conductor 7 according to FIG. 2, the composite 15 is now brought into contact with the jacket parts 3. In this method step, a seam surface 5* is directly arranged on the jacket parts 3. A second defined quantity of auxiliary sealant 9* is applied to a delimited section 8* of the seam surface 5* of one of the jacket parts 3. The delimited section is an uneven area and corresponding adjoining areas of the seam surface 5*. During an application of heat, the auxiliary sealant 9* between seam surfaces 5* and the composite 15 can melt and form a material bond with the composite 15 and the jacket parts 3. The advantages which were already described with respect to the use of auxiliary sealant also result here.

### LIST OF REFERENCE NUMERALS

1 electrochemical cell
2 jacket
3 jacket part
4 seam section
5 seam surface
6 current conductor feedthrough
7 current conductor
8 delimited section
9 auxiliary sealant
10 conductor narrow side
11 conductor wide side
12 presealing film
13 band
14 sealing bar
15 composite
E plane

1. A method for producing an electrochemical cell (1), the electrochemical cell (1) having at least one electrode stack, which is received inside a jacket (2), the jacket (2) being formed from at least two jacket parts (3), the jacket parts (3) each having at least one seam surface (5), on which the jacket parts (3) can be at least partially brought into contact with one another, comprising the following method steps:
applying a defined quantity of an auxiliary sealant (9) at least indirectly to a delimited section (8) of the seam surface (5) of at least one of the jacket parts (3);
bringing the seam surface (5) of one of the jacket parts (3) into contact with the seam surface (5) of another of the jacket parts (3);
subsequently applying heat to the seam surfaces (5)
wherein the auxiliary sealant (5) is brought into at least indirect contact with a current conductor (7), in particular with a conductor narrow side (10) of a current conductor (7).

2. The method according to claim 1,
wherein the auxiliary sealant (9) changes its shape during the application of heat.

3. The method according to claim 2,
wherein the seam surfaces (5) are arranged directly on one of the jacket parts (3).

4. The method according to claim 3,
wherein the seam surface (5), at least on the delimited section (8) is arranged at least partially on a presealing element (12), in particular a presealing film, separate from the jacket part (3), and that the separate presealing element (12) is connected to at least one of the jacket parts (3) in a further method step.

5. The method according to claim 4,
wherein the seam surfaces (5) of at least two jacket parts (3) are jointly arranged on a separate presealing element (12) in the delimited section, a current conductor (7) being fixedly connected together with the auxiliary sealant (9) to the presealing element (12), in particular enclosed in a ring shape, and subsequently the current conductor (7) being brought into contact, together with the auxiliary sealant (9) and the presealing element (12), with at least one of the jacket parts (3).

6. The method according to claim 5,
wherein the seam surfaces (5) and the auxiliary sealant (9) are produced from a similar material, in particular from an identical material.

7. The method according to at claim 6,
wherein the seam surface (5) has an uneven contour on the delimited section (8).

8. (canceled)

9. The method according to claim 7,
wherein a composite (15) made of at least one current conductor (7), at least one defined quantity of auxiliary sealant (9), and at least one presealing element (12) is brought into contact with at least one of the jacket parts (3), a second defined quantity of an auxiliary sealant (9*) being applied to a delimited section between the jacket part (3) and the composite (15).
